(19) United States
(12) Patent Application Publication
(10) Pub. No.: US 2026/0210353 A1
(43) Pub. Date: Jul. 23, 2026

(54) MACHINE TOOL FOR REMOVING WORN-OUT LINERS FROM RECIPROCATING COMPRESSOR CYLINDERS AND RELATED METHOD OF REMOVAL

(71) Applicant: NUOVA SIMAT S.R.L., Collesalvetti (LI) (IT)

(72) Inventors: Dario LONGOBARDI, Collesalvetti (LI) (IT); Enricomarialuigi ACCASCINA, Collesalvetti (LI) (IT)

(21) Appl. No.: 19/140,878

(22) PCT Filed: Dec. 22, 2023
(86) PCT No.: PCT/IB2023/063197

§ 371 Date: Jun. 18, 2025

(30) Foreign Application Priority Data
Dec. 22, 2022 (IT) 102022000026520

(51) Int. Cl. F04B 53/22; B23C 3/30

(52) U.S. Cl. CPC F04B 53/22; B23C 3/30

(57) ABSTRACT

A portable machine tool for removing a worn-out liner of a cylinder of a reciprocating compressor includes linear guide means, an axial slide sliding on the guide means, a radial slide sliding on the axial slide, first motor means for driving the axial slide on the guide means, a tool holder unit mounted on the radial slide and equipped with a tool eccentrically arranged with respect to an advancement direction of said axial slide on the guiding means. The machine also includes second motor means for driving the tool integral to the radial slide, first attachment means of the guide means to the front end of the cylinder and second attachment means of the guide means to the back end at the stuffing box side of the cylinder. The attachment means include means for centering the guide means with respect to the longitudinal axis of the cylinder.

### FIELD OF THE INVENTION

The present invention generally relates to maintenance activities of reciprocating compressors and more particularly refers to a machine tool for removing worn-out liners from reciprocating compressor cylinders. The invention also concerns a worn-out liners removal method.

### BACKGROUND ART

As is known, replacement of worn cylinder liners is one of the periodic maintenance operations to be carried out on reciprocating compressors. The liners are cylindrical metal bushings that wear out due to the sliding of the piston in the cylinder. The liner is fitted into the cylinder by interference and, once worn due to rubbing with the piston, must be replaced. Currently, to carry out this operation the cylinder is dismantled from the rest of the machine and transferred to a properly equipped workshop. Here the cylinder is placed in a vertical position on a stationary machine tool, generally a three-axis milling machine, with a tool arranged eccentrically, and a machining is started to create a groove along the liner generatrix of increasing depth for the progressive material removal. After a certain number of tool passages, the thickness of the material is reduced to a limit value beyond which the pressure exerted by the cylinder overcomes the resistance of the material, causing it to collapse and thus allowing the extraction of the liner.

The need to dismantle the cylinder from the machine body and transfer it to an equipped workshop is a labor intensive and expensive operation also in terms of time required and it would therefore be desirable to be able to carry out this operation on site without the need to dismantle the cylinder.

CN 203401288U discloses a compressor cylinder sleeve detacher with an expansion device pressing against the inner wall of the cylinder sleeve, the frictional force between the expansion device and the cylinder sleeve being higher than the binding force between the cylinder sleeve and the shell. By moving the expansion device the cylinder sleeve can be pulled out together with the expansion device.

### SUMMARY OF THE INVENTION

The general object of the present invention is to provide a machine tool for removing worn-out liners from reciprocating compressor cylinders which allows to overcome the above-mentioned prior art drawbacks.

A particular object of the present invention is to provide a machine tool of the aforementioned type which is portable whereby the operation of removing the worn-out liner from the cylinder of a reciprocating compressor can be performed on site without having to dismantle the cylinder.

Another object of the present invention is to provide a machine tool of the aforementioned type which is easy to handle and easy to transport and install.

It is another object of the present invention to provide a method for removing worn-out liners from reciprocating compressor cylinders which avoids disassembly of the cylinder from the compressor body.

These objects are achieved with the machine tool for removing worn-out liners from cylinders of reciprocating compressors and with the relevant worn-out cylinder removal method according to the present invention whose essential features are set forth in the present application. Further important features are set forth in the present application.

According to the invention, a portable machine tool is provided for removing a worn-out liner of a cylinder of a reciprocating compressor, in which the cylinder comprises a body in which the liner to be removed is axially housed, and a front end and a back end at stuffing box side. The machine comprises linear guide means, an axial slide sliding on the guide means, a radial slide sliding on the axial slide, first motor means for driving the axial slide on the guide means, a tool holder unit mounted on the radial slide and equipped with a tool eccentrically arranged with respect to an advancement direction of said axial slide on the guide means. The machine also includes second motor means for driving the tool integral to the radial slide, first attachment means of the guide means to the front end of the cylinder and second attachment means of the guide means to the back end at the stuffing box side of the cylinder comprising means for centering the guide means with respect to the longitudinal axis of the cylinder.

Preferably, first attachment means of the guide means to the front end of the cylinder comprises an attachment ring suitable to be fixed to the front end, a pair of supports extending from said ring. The supports define a support plane for a transverse plate integral to the guide means, the connection of said supports to the attachment ring and the connection between said supports and the transverse plate being configured to be adjustable in two mutually perpendicular directions lying on a plane perpendicular to the guide means.

Preferably, each of the supports comprises a plate integral to the attachment ring and an angle bracket, the position of which is adjustable in one of said perpendicular directions.

Preferably, the transverse plate is slidable on the angle brackets in the other of said perpendicular directions.

Preferably, the attachment ring is fixable to said front end of the cylinder by screws passing through arc-shaped slotted seats aligned along a circumference on said ring.

Preferably, the second attachment means of the guide means to stuffing box side back end of the cylinder comprise an attachment flange suitable of engaging in the back end of the cylinder and an oscillating connection means for connecting said attachment flange to the guide means. Preferably, the guide means are integral to a support base carrying said transverse plate at one end and a plate connectable to the attachment flange through a ball joint.

Preferably, the radial slide carrying the tool is mounted on said axial slide in an adjustable fashion according to the radial direction.

According to another important feature of the invention, a method is provided for removing a worn-out liner from the cylinder of a reciprocating compressor unit, comprising the following steps:
removing the piston and the head of said cylinder;
coaxially mounting in the cylinder a machine tool equipped with a tool capable of forming a groove in the liner along a generatrix of the cylinder, until reaching a depth of the groove in the liner such that the liner is collapsed at said groove;
withdrawing the liner from the cylinder;
said machine tool being portable, whereby the operating steps can be performed without removing the cylinder from the compressor unit.

In a particularly preferred embodiment the machine tool is the portable machine tool according to the invention.

### BRIEF DESCRIPTION OF THE DRAWINGS

These and other characteristics, as well as the advantages, of the machine tool for removing worn-out liners from cylinders of reciprocating compressors according to the present invention will be apparent from the following description of one of its embodiments made by way of example and without limitation with reference to the attached drawings in which:

FIG. 1 is an overall perspective view of the machine tool for removing worn-out liners from reciprocating compressor cylinders according to the present invention;

FIG. 2 is a perspective view in longitudinal section of the machine tool of FIG. 1 mounted within a reciprocating compressor cylinder;

FIG. 3 is a view of the mounted machine tool of FIG. 2 according to an axial view from the front end of the cylinder;

FIG. 4 is a detailed sectional view of the axial and radial slide assembly of the machine in FIG. 1 ;

FIGS. 5 and 5a show a front view of a front attachment ring and an enlarged detail view thereof;

FIG. 6 is a side view of the ring of FIG. 5;

FIGS. 7 and 8 show a perspective view and, respectively, a cross section of a back attachment flange.

### DETAILED DESCRIPTION OF THE INVENTION

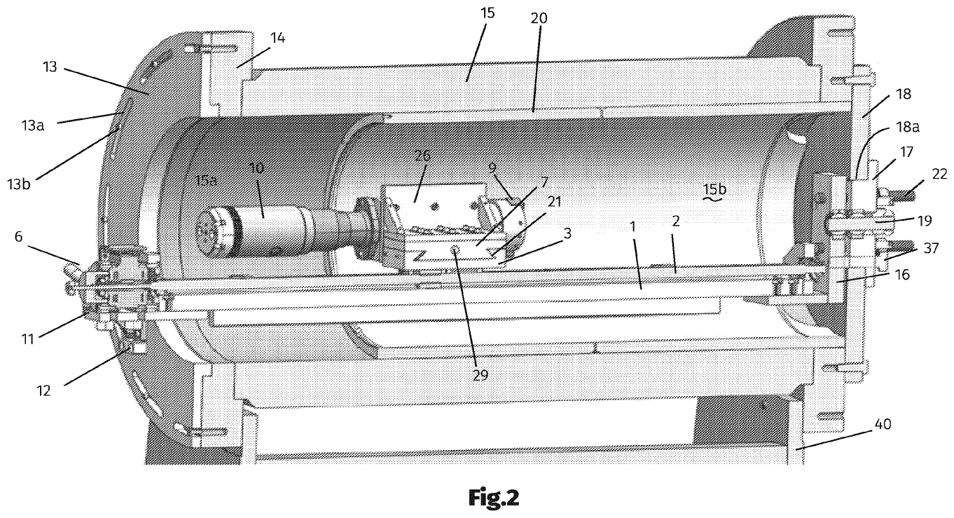

An embodiment of the machine tool according to the invention is shown in the attached figures. In particular in FIG. 2 the machine tool of the invention is shown in a condition mounted axially inside a cylinder 15 of a reciprocating compressor, a liner 20 to be removed being positioned on the internal surface of the cylinder. It should be noted that according to the present invention the cylinder, and consequently the machine tool mounted therein, are in a horizontal position, and the terms “front” and “back” are to be understood with reference to the end of the cylinder into which the machine tool is inserted and, respectively, its opposite end.

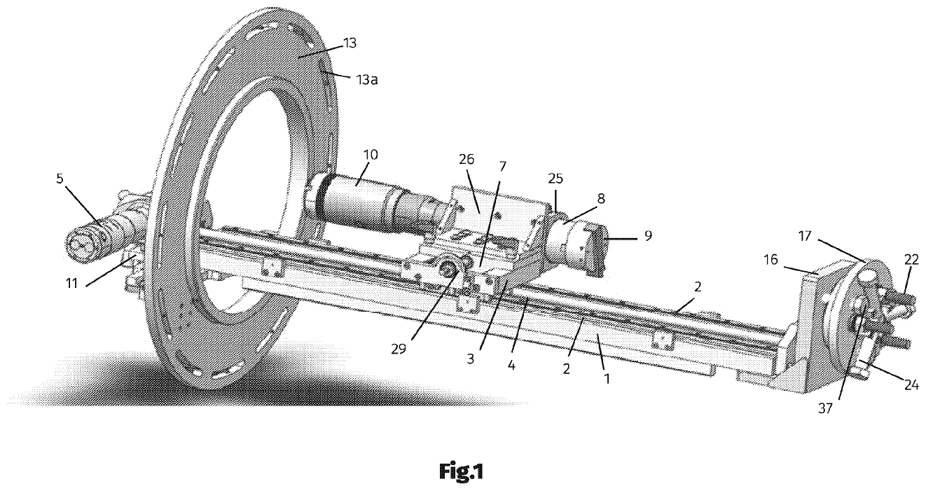

With reference to FIG. 1, the machine tool according to the invention comprises a support bar 1, a pair of parallel linear guides 2 extending along the support bar 1 and having a dovetail shaped section, an axial slide 3 slidingly mounted on the guides 2 and a driving screw 4, preferably a ball screw, engaged in the slide 3. The screw 4 is rotated by a motor 5, for example of the pneumatic type, equipped with a suitable gearmotor 6 of conventional type.

The machine tool according to the invention also includes a radial slide 7 mounted so as to slide on the axial feed slide 3 in a direction perpendicular to the sliding direction of the latter. A spindle 8 is rotatably mounted on the radial slide 7 and the axis of the spindle 8 is parallel to the advancement axis of the axial slide 3. The spindle 8 carries a tool 9 and is rotated by a motor 10, for example of the pneumatic type.

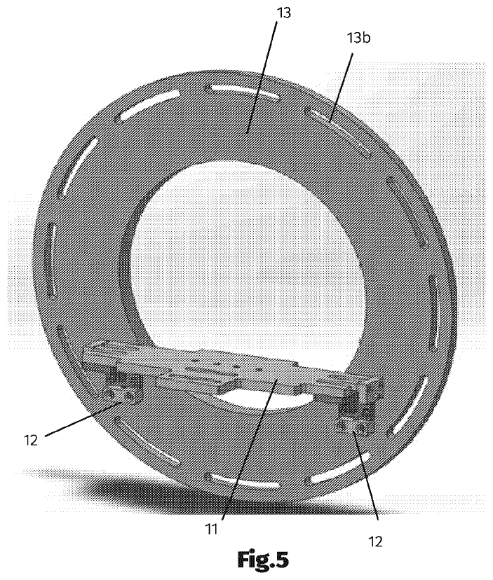

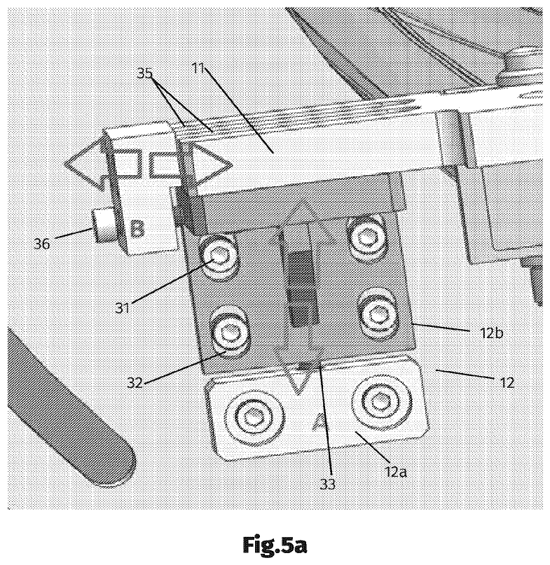

As also shown in particular in FIGS. 5 and 6, it has been indicated at 13 an attachment ring for fixing the machine tool to the cylinder 15. In particular, a front transverse plate 11 extends from the front end of the support bar 1 perpendicular to the support bar 1, while two saddles 12 extend from one face of the attachment ring 13, defining a support surface on which the transverse plate 11 is fixed. When using the machine tool, the attachment ring 13 is secured to a end flange 14 of the cylinder 15 by means of screws 13a through circular-arc slotted seats 13b aligned on said ring along a circumference.

The transverse plate 11 and the two saddles 12 are configured to slide along respective orthogonal directions, indicated with A and B in FIG. 5a, lying on a common plane perpendicular to the axial advancement direction of the slide 3 and, consequently, once the machine tool of the invention has been mounted in the cylinder 15, perpendicular to the axis of the cylinder itself. The sliding in both directions of the transverse plate 11 and the two saddles 12 serves to center the machine tool on the cylinder.

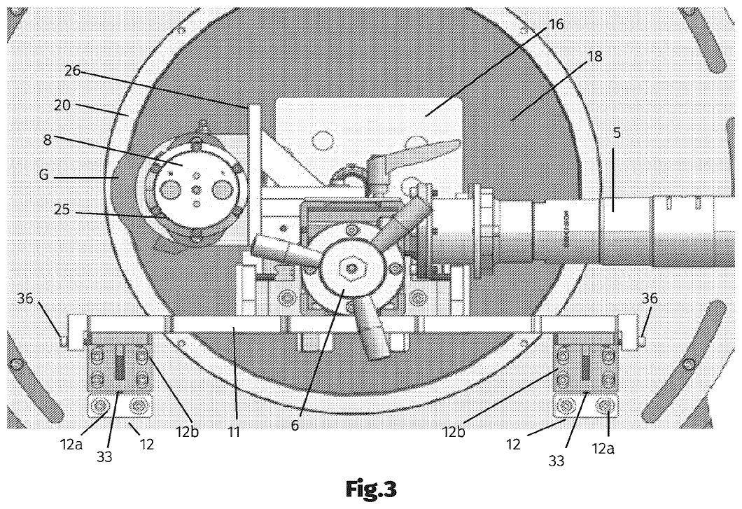

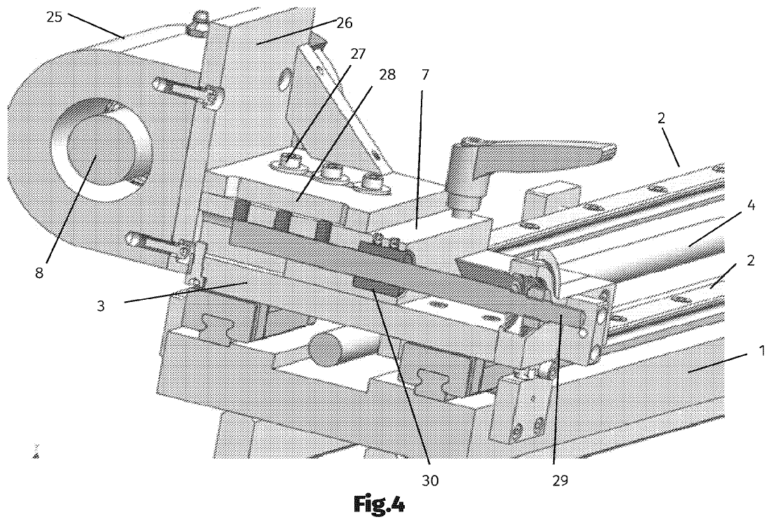

As shown in FIGS. 3, 5 and 5a, the saddles 12 are formed by a plate 12a integral with the attachment ring 13 and by an angle bracket 12b, defining the support surface for the transverse plate 11. The angle bracket 12b can be fixed to the attachment ring 13 via screws 31 through slots 32 and rests on an adjustment screw 33 engaged in fixed plate 12a, thus allowing the position of the support surface of transverse plate 11 to be height adjusted according to direction A.

The transverse plate 11 is configured to slide on the angle brackets 12b in direction B. For this purpose a coupling is provided via pins 34 protruding from the angle brackets 12b which engage in corresponding slotted seats 35 at the ends of the transverse plate 11. To lock the transverse plate 11 with respect to the saddles 12, adjustment screws 36 are provided, engaged in the ends of the transverse plate 11 and abutting against the respective angle brackets 12b

The gearmotor 6 of the motor 5 which controls the axial advancement of the slide 3 is fixed on the transverse plate 11.

A back plate 16, lying on a plane orthogonal to the axial advancement direction of the slide 3, extends from the rear end of the support bar 1. An attachment flange 17 is connected to the back plate 16 for attaching the machine tool to the cylinder 15 (see FIG. 2).

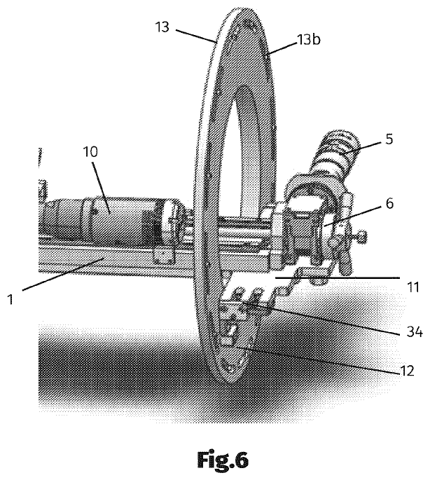

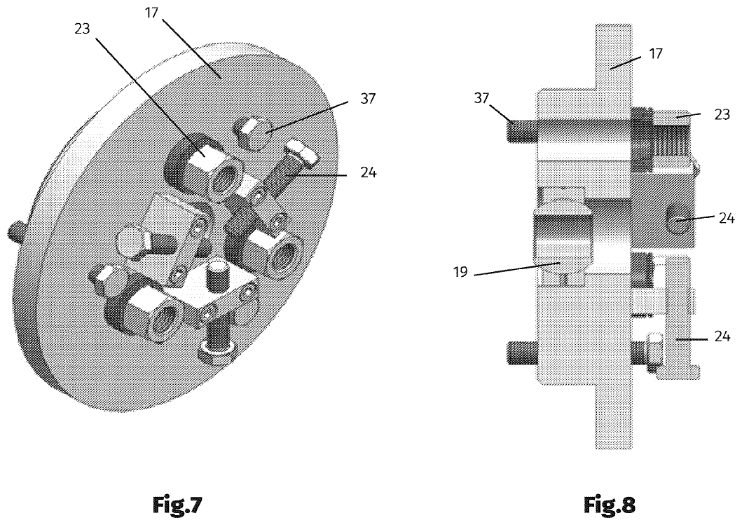

As also shown in FIGS. 7 and 8, the attachment flange 17 is shaped so as to replicate the shape of the stuffing box of the cylinder 15, i.e. it has a diameter equal to that of stuffing box seat 18a formed in the rear wall 18 of the cylinder 15. Back plate 16 will be fixed to the flange 17 by means of bolts 22 engaged in nuts 23 fixed on the flange 17, after the machine tool has been centered with respect to the cylinder 15.

The attachment flange 17 is connected to the back plate 16 by means of a spherical joint 19 which acts as a fulcrum during the centering maneuvers of the machine tool inside the cylinder 15. The centering of the machine tool is achieved through the action of screws 24 on flange 17, acting as pushers on the pin of joint 19 to cause the necessary centering displacements of the machine tool. Screws 37 are also provided on the flange 17 to counteract the movement of the back plate 16 towards the wall 18 when tightening the bolts 22 with the nuts 23.

The advancement of the axial slide 3 and the rotation of the tool spindle 8 are regulated via control valves of the pneumatic motors. The axial stroke of the machine is 1000 mm in the present embodiment, but it can be adjustable and therefore take on different values by fixing the base 1 at different points with respect to the attachment ring 13.

The position of the radial slide 7 with respect to the axial slide 3 is adjustable to ensure the correct positioning of the tool 9 with respect to the surface of the liner 20. For this purpose the two slides are coupled by means of a dovetail connection 21 and two tool position adjustment groups 9 are provided for macro-adjustment and fine adjustment of the tool position. For this purpose, the tool spindle 8 is rotatably mounted in a support 25 integral with a plate 26, which is fixed in an adjustable manner to the radial slide 7 by means of screws 27 which engage in slotted seats 28 formed in the plate 26. The slots 28 extend in a radial direction and therefore loosening the screws results in the spindle 8 to slide radially, thus allowing a first adjustment of the position of the tool 9. The fine adjustment is carried out by means of a micrometric screw 29 integral with the radial slide 3 which engages in a scroll 30 integral with the radial slide 7.

The maximum radial stroke is 80 mm.

As shown in FIG. 3, the tool 9 is in an eccentric position with respect to the guides 2 and, therefore, to the axis of the cylinder 15 once the machine tool has been mounted in it. The tool is provided with rotary motion around its own axis and translational motion along the axis of the cylinder 15. In this way the contact with the surface of the liner 20 produces a progressive removal of material resulting in a groove G of increasing depth along a generatrix following successive passes of the tool. The thickness of the liner in the groove 21 is reduced to a limit value beyond which the forcing pressure due to the initial interference exceeds the resistance of the material at the section of minimum thickness and the liner fractures, imploding towards the inside.

The method according to the invention exploits this effect to allow the removal of a worn-out liner from a cylinder of a reciprocating compressor as in the known art, but, unlike it, does not require dismantling the cylinder from the crankcase (indicated with 40 in the FIG. 2) of the compressor and its transfer to a properly equipped workshop where the above processing is carried out with a special stationary machine tool.

In fact, according to the method of the invention, when the liner of a cylinder of a reciprocating compressor requires to be extracted from the cylinder because it is worn, the cylinder head is removed and the piston removed from it without dismantling the cylinder from the crankcase 40 of the compressor. The portable machine tool of the invention is then inserted Inside the cylinder, which is in a horizontal position, the machine being equipped with a tool capable of forming a groove in the liner along a cylinder generatrix, until reaching a groove depth such as to cause the liner material to collapse. According to the invention, the machine tool is fixed to the cylinder in an axial position so that the tool works in an eccentric position with respect to the cylinder axis. The axial centering of the machine is measured, for example, using a pair of comparators positioned on the axial slide and placed at 0° and 90° with respect to the tool working area. After each complete stroke of the axial slide, the position of the machine is corrected up to an acceptable value, for example 0.05 mm of maximum oscillation on the single dial indicator in a complete stroke.

When the machine tool has been correctly centered, the position of the tool relative to the surface of the liner is adjusted and then the machine is started. After each complete stroke of the tool, its position relative to the surface of the liner is adjusted to allow the tool to encounter other material to be removed in the next pass. Once the limit thickness has been reached and the material has collapsed, the liner is extracted through special conventional extractor means. If extraction is difficult, a second groove can be made in the liner using the same method.

The portable machine tool according to the present invention is particularly advantageous for carrying out this function. Thanks to the means for attaching the machine tool to the cylinder, centering operations are quick and easy. Specifically, back plate 16 is engaged on the ball joint 19 of the flange 17 and then flange 17 is engaged in the opening 18a of the end wall 18 of the cylinder 15. Then attachment ring 13 is fixed to the front end of the cylinder 15 and the transverse plate 11 is placed on the saddles 12 of the ring 13. The centering of the machine tool with respect to the axis of the cylinder 15 in the front area is carried out by acting on the position of the angle brackets 12b with respect to the plates 12a and on the end slots of the transverse plate 11. The adjustment in the back area is carried out by acting on the screws 24 which point to the pin 19; the pin acts as a 1st type lever by moving the plate 16 and the base 1 integral with it. The fixing of the ring 13 to the cylinder through the slotted seats 13b allows the ring 13 to be rotated, the base 1 and the plate 16 rotating with it, having the spherical joint 19 as the fulcrum.

Functional tests were carried out with a prototype of the portable machine tool according to the invention on a mock-up that recreated the geometries and mechanical relationships typical of a cylinder/liner system. For this purpose, the liner was installed inside the cylinder by hot assembly. After the machine was centered, with a value of 0.05 mm considered acceptable on the complete stroke, processing was started and at the end the following performances were recorded:
45 minutes for a single complete pass;
2 mm maximum depth for each pass.

Since the mock-up material is more workable than the liner material of real cylinders, the expected cutting depth under real conditions is approximately 1 mm.

The portable machine tool according to the present invention can be sized for various diameters and lengths of compressor cylinder, in particular for example: liner inner diameter from 230 mm to 555 mm; stroke from 400 mm to approximately 1050 mm) without altering its operating characteristics. In practice it can be tailor-made for each specific application. The machine can therefore be completely modeled according to the customer needs, the type of operation or the available space in the various situations to be faced. This implies that this machine has been studied from the perspective of scalability, i.e. that a re-size of the machine corresponds to a re-size of its components (such as the front and rear attachment means and/or the advancement slide) without any intervention on the layout or operating logic.

The portable machine tool and the liner removal method according to the invention can be advantageously used in every sector in which reciprocating compressors that require liner replacement are used, from Oil & Gas to civil, from Manufacturing to Steel sectors.

Variations and/or modifications may be made to the portable machine tool for removing worn-out liners from the cylinders of reciprocating compressors and the related worn-out liners removal method according to the present invention without departing from the scope of the invention as defined in the following claims.

1. A portable machine tool for removing a worn-out liner of a reciprocating compressor cylinder, said cylinder comprising a body, in which the liner to be removed is axially housed, and a front end and a stuffing box side back end, the machine tool being characterized in that it comprises linear guide means, an axial slide sliding on said guide means, a radial slide sliding on said axial slide, first motor means for driving said axial slide on said guide means, a tool holder unit mounted on said radial slide and equipped with a tool eccentrically arranged with respect to an advancement direction of said axial slide on said guide means, second motor means for driving said tool integral to said radial slide, first attachment means of said guide means to said front end of the cylinder and second attachment means of said guide means to said stuffing box side back end of the cylinder comprising means for centering said guide means with respect to the longitudinal axis of the cylinder.

2. The portable machine tool according to claim 1, wherein said first attachment means of said guide means to the front end of the cylinder comprises an attachment ring suitable to be fixed to said front end, a pair of supports extending from said ring, said supports defining a support plane for a transverse plate integral to said guide means, the connection of said supports to said attachment ring and the connection between said supports and said transverse plate being configured to be adjustable in two mutually perpendicular directions (A, B) lying on a plane perpendicular to said guide means.

3. The portable machine tool according to claim 2, wherein each of said supports comprises a plate integral to the attachment ring and an angle bracket the position, of which is adjustable in one of said perpendicular directions (A).

4. The portable machine tool according to claim 3, wherein said transverse plate is slidable on said angle brackets in the other of said perpendicular directions (B).

5. The portable machine tool according to claim 2, wherein said attachment ring is fixable to said front end of the cylinder by screws passing through arc shaped slotted seats aligned along a circumference on said ring.

6. The portable machine tool according to claim 1, wherein said second attachment means of said guide means to stuffing box side back end of the cylinder comprise an attachment flange suitable of engaging in the back end of the cylinder and an oscillating connection means for connecting said attachment flange to said guide means.

7. The portable machine tool according to claim 1, wherein said radial slide carrying the tool is mounted on said axial slide in an adjustable fashion according to the radial direction.

8. The portable machine tool according to claim 1, wherein said guide means are integral to a support base carrying said transverse plate at one end and a plate connectable to said attachment flange through a ball joint.

9. A method for removing a worn-out liner from a cylinder of a reciprocating compressor unit, comprising
removing the piston and the head of said cylinder;
and characterized in that it comprises the following steps:
coaxially mounting in said cylinder a machine tool equipped with a tool suitable of forming a groove in said liner along a generatrix of said cylinder, until a depth in said liner is reached such that the liner material is collapsed at said groove;
withdrawing said liner from the cylinder;
said machine tool being portable, whereby said operating steps can be performed without removing the cylinder from the compressor unit.

10. The method according to claim 9, wherein said machine tool is a portable machine tool according to claim 1.
